(19) United States
(12) Patent Application Publication
(10) Pub. No.: US 2009/0193384 A1
(43) Pub. Date: Jul. 30, 2009

(54) SHIFT-ENABLED RECONFIGURABLE DEVICE

(75) Inventors: Mihai Sima, Victoria (CA); Scott Alexander Miller, Victoria (CA); Michael Liam McGuire, Victoria (CA)

Correspondence Address: MIHAI SIMA, 201-3259 Alder Street, Victoria, B.C., V8X 1P3, CA

(73) Assignees: MIHAI SIMA, Victoria (CA); SCOTT ALEXANDER MILLER, Victoria (CA); MICHAEL LIAM McGUIRE, Victoria (CA)

(21) Appl. No.: 12/352,562

(22) Filed: Jan. 12, 2009

Related U.S. Application Data
(60) Provisional application No. 61/023,827, filed on Jan. 25, 2008.

(51) Int. Cl. G06F 17/50

(52) U.S. Cl. 716/16; 716/17

(57) ABSTRACT

A coarse-grain reconfigurable array that implements shift operations within its interconnection network is disclosed. The interconnection network of such a coarse-grain reconfigurable array contains partially or fully populated matrices of switches, where each such matrix of switches is obtained by merging a standard diagonal switch matrix with an array shift unit. The disclosed device provides better performance when the standard routing and shift functions are both required.

### FIELD OF THE INVENTION

The present invention relates to interconnection structures used in reconfigurable hardware, such as coarse-grain reconfigurable devices or arrays. More specifically, the invention relates to implementation of shift operations within the programmable interconnection structures such as those provided within a coarse-grain reconfigurable array.

### BACKGROUND OF THE INVENTION

With the advent of wireless communications, pattern recognition, speech and image processing, it becomes increasingly important to compensate for non-linear effects and multiplicative noise. The signal processing in these domains typically employs the calculation of transcendental functions. On the embedded platforms of greatest interest, the computation is performed using fixed-point arithmetic with reduced word-length. The common Taylor or Chebyshev series expansions translate to a sequence of multiplications, additions, and memory look-up operations. The support for this approach is problematic on embedded platforms, since the word-length required for a given precision increases linearly with the number of consecutive multiplications in the series expansions. Thus, other solutions are needed.

Iterative algorithms that calculate transcendental functions using simple hardware are outlined for example in I. Koren, Computer Arithmetic Algorithms, second edition, A. K. Peters, 2001, and J.-M. Muller, Elementary Functions: Algorithms and Implementation, second edition, Birkhäuser Boston, 2005. Common to these algorithms are Shift-and-Add and Shift-and-Subtract operations, where the order of shift is programmable. Since these algorithms are sequential, a software solution is inherently slow even on powerful parallel processors. In addition, a fast shift unit is difficult to implement since it requires customization at the layout level as described in N. Weste and D. Harris, CMOS VLSI Design: A Circuits and Systems Perspective, third edition, Addison Wesley, 2004.

Examples of fast shift-unit implementations are presented in G. Tharakan and S. Kang, “A New Design of a Fast Barrel Switch Network,” IEEE Journal of Solid-State Circuits, vol. 27, no. 2, February 1992, pp. 217-221; R. Pereira, J. Michell, and J. Solana, “Fully Pipelined TSPC Barrel Shifter for High-Speed Applications,” IEEE Journal of Solid-State Circuits, vol. 30, no. 6, June 1995, pp. 686-690; P. A. Beerel, S. Kim, P.-C. Yeh, and K. Kim, “Statistically Optimized Asynchronous Barrel Shifters for Variable Length Codecs,” Proceedings of the ACM International Symposium in Low Power Electronics and Design. San Diego, Calif., August 1999, pp. 261-263; R. Rafati, S. M. Fakhraie, and K. C. Smith, “A 16-Bit Barrel-Shifter Implemented in Data-Driven Dynamic Logic (D³L),” IEEE Transactions on Circuits and Systems—I: Regular Papers, vol. 53, no. 10, October 2006, pp. 2194-2202; and S. Miller, M. Sima, and M. McGuire, “VLSI Implementation of a Shift-Enabled Reconfigurable Array,” Proceedings of the IEEE International Symposium on Circuits and Systems, Seattle, Wash., May 2008, pp. 1360-1363. The resulting customized shift unit is indeed fast but it lacks flexibility, since it does not support operations that it was not originally designed for. As a result, the implementing circuitry serves no purpose and wastes silicon area when a shift operation is not immediately required.

The Reconfigurable Computing paradigm provides hardware-like performance with software-like flexibility, as described in D. A. Buell and K. L. Pocek, “Custom Computing Machines: An Introduction,” Journal of Supercomputing, vol. 9, no. 3, 1995, pp. 219-230; and S. A. Hauck, “The Roles of FPGA's in Reprogrammable Systems,” Proceedings of the IEEE, vol. 86, no. 4, April 1998, pp. 615-638. In Reconfigurable Computing, application-specific computing units are defined and then instantiated onto a reconfigurable array. This way, a large number of customized computing units are emulated.

The optimum reconfigurable array architecture is still an open question. Initially, fine-grain arrays, e.g., Field-Programmable Gate Arrays (FPGA), have been considered, as described in A. DeHon, “Reconfigurable Architectures for General-Purpose Computing,” Massachusetts Institute of Technology, Technical Note A.I. 1586, Cambridge, Mass., October 1996. A fine-grain array typically consists of a large number of simple computing tiles, e.g., look-up tables, and a rich interconnection network. Well known devices in the fine-grain class are Virtex and Spartan from Xilinx Incorporated, San Jose, Calif., http://www.xilinx.com/, and Stratix and Cyclone from Altera Corporation, San Jose, Calif., http://www.altera.com/. In spite of their flexibility in implementing circuits, the fine-grain arrays are expensive in terms of silicon area, reconfiguration time, and power consumption. In addition, the existing fine-grain arrays, do not provide architectural support for shift operations, which makes the implementation of the shift operation difficult. Thus, a programmable shift is emulated by costly multiplexing logic implemented within the computing tiles as described in P. Metzgen, “A High Performance 32-bit ALU for Programmable Logic,” Proceedings of the 12th ACM/SIGDA International Symposium in Field Programmable Gate Arrays, Monterey, Calif., pp. 61-70, February 2004.

In order to reduce the penalties of fine-grain arrays, coarse-grain arrays have been proposed. Such an array consists typically of a set of coarse-grain computing tiles, e.g., Arithmetic Logic Unit (ALU), surrounded by a word-level programmable interconnection network. Well known devices in the coarse-grain class are RaPiD described in C. Ebeling, D. C. Cronquist, and P. Franklin, “RaPiD—Reconfigurable Pipelined Datapath,” Proceedings of the 6th International Workshop on Field Programmable Logic and Applications. Field-Programmable Logic: Smart Applications, New Paradigms and Compilers, ser. Lecture Notes in Computer Science (LNCS), vol. 1142. Springer-Verlag, September 1996, pp. 126-135; PipeRench described in S. C. Goldstein, H. Schmit, M. Moe, M. Budiu, S. Cadambi, R. R. Taylor, and R. Laufer, “PipeRench: A Coprocessor for Streaming Multimedia Acceleration,” Proceedings of the 26th International Symposium in Computer Architecture, Atlanta, Ga., May 1999, pp. 28-39; and MATRIX described in E. Mirsky and A. DeHon, “MATRIX: A Reconfigurable Computing Architecture with Configurable Instruction Distribution and Deployable Resources,” Proceedings of the 4th IEEE Symposium in FPGAs for Custom Computing Machines, Napa Valley, Calif., April 1996, pp. 157-166. The computing tile of a coarse-grain array operates on word-level operands, generates word-level results, and has a specific repertoire of instructions. The programmable interconnection network provides word-level routing operations. Assume N is the word-length of the coarse-grain computing tile. The connection point for a coarse-grain array is then an N-by-N diagonal matrix of switches, which is called a diagonal switch-box. It is apparent that a coarse-grain array has a lower flexibility than a fine-grain array in implementing circuits. However, this is not a major limitation if the array architecture is geared to an application. Considering the Digital Signal Processing (DSP) domain, a coarse-grain reconfigurable array includes multipliers and adders to support Multiply-and-ACcumulate (MAC)-based computation as described, for example, in C. Ebeling, D. C. Cronquist, and P. Franklin, “RaPiD—Reconfigurable Pipelined Datapath,” Proceedings of the 6th International Workshop on Field Programmable Logic and Applications. Field-Programmable Logic: Smart Applications, New Paradigms and Compilers, ser. Lecture Notes in Computer Science (LNCS), vol. 1142. Springer-Verlag, September 1996, pp. 126-135. However, many of the DSP systems require the evaluation of transcendental functions, such as trigonometric, exponential, and logarithmic functions, which cannot be evaluated efficiently with MAC arithmetic units in fixed-point arithmetic with reduced word-length.

Alternatives to the MAC-based techniques are the Convergence Computing Method (CCM) and CO-ordinate Rotation DIgital Computer (CORDIC) iterative techniques which require only shifts, additions, and table look-ups. Considering the CCM, the basic principle of calculating the logarithm of a number M, where 0.5≦M<1.0, is cyclic multiplication of M by 1.0 or a series of specially chosen factors, as necessary, until the product falls in a predefined range, (1.0 . . . 1.0+Δ), as described in R. W. Bemer, “A Subroutine Method for Calculating Logarithms,” Communications of the ACM, vol. 1, no. 5, May 1958, pp. 5-8. Let the final product in the range be mₖ, so that:

$$\begin{matrix}1 \leq {m}_{k} \leq ( 1 + Δ ) , & where {m}_{k} = M {\prod }_{i = 1}^{k} {A}_{i}\end{matrix} \qquad ( 1 )$$

By taking the logarithm of the previous identity, it results that

$$log M = log {m}_{k} - {\sum }_{i = 1}^{k} log {A}_{i} \qquad ( 2 )$$

where log mₖ≈0 within the required precision specified by the constant Δ. Under such circumstances, the logarithm of M is approximated as a sum of predefined constants:

$$log M \approx - {\sum }_{i = 1}^{k} log {A}_{i} \qquad ( 3 )$$

The factors Aᵢ are of the form 1+2⁻ⁱ. Thus, a multiplication by Aᵢ reduces to one addition and one shift. The constants log(1+2⁻ⁱ) are precomputed and stored into memory. Therefore, they only contribute with the latency of a memory look-up operation to the total computing time budget.

The exponential of a number M, where 0≦M<1, can be calculated in a similar way, by cyclic addition to M of series of specially chosen summands, as necessary, until the sum falls in a specially chosen range, (0.0 . . . Δ) as described in W. H. Specker, “A Class of Algorithms for Ln x, Exp x, Sin x, Cos x, Tan⁻¹ x and Cot⁻¹ x,” IEEE Transactions on Electronic Computers, vol. EC-14, no. 1, February 1965, pp. 85-86. Denoting the final sum in the chosen range as mₖ, we obtain:

$$\begin{matrix}0 \leq {m}_{k} \leq Δ , & where {m}_{k} = M - {\prod }_{i = 1}^{k} {A}_{i}\end{matrix} \qquad ( 4 )$$

Applying the exponential to both sides of (4), it results that:

$$exp M = ( exp {m}_{k} ) {\prod }_{i = 1}^{k} exp {A}_{i} \approx {\prod }_{i = 1}^{k} exp {A}_{i} \qquad ( 5 )$$

since exp mₖ≈1.0 within the required precision specified by the constant Δ. Consequently, the exponential of M is approximated as a product of predefined constants, exp Aᵢ. The factors Aᵢ are either 0 or of the form log(1+2⁻ⁱ), such that a multiplication of exp M by a factor exp Aᵢ reduces to one addition and one shift operations. The constants Aᵢ=log(1+2⁻ⁱ) are precomputed and stored into a LUT. Therefore, they only contribute with the latency of a memory look-up operation to the total computing time budget.

The square, and the cubic root can be calculated in a similar way as described in R. W. Bemer, “A Machine Method for Square-Root Computation,” Communications of the ACM, vol. 1, no. 1, January 1958, pp. 6-7. These iterative techniques that use only Shift-and-Add operations are generally referred to as the Convergence Computing Method or CCM for short, as mentioned in T. C. Chen, “Automatic Computation of Exponentials, Logarithms, Ratios, and Square Roots,” IBM Journal of Research and Development, vol. 16, no. 4, July 1972, pp. 380-388.

Trigonometric functions can also be calculated by iterations with only shifts, additions, and table look-ups using the CORDIC method as described in J. E. Volder, “The CORDIC trigonometric computing technique,” IRE Transactions on Electronic Computers, vol. EC-8, no. 3, September 1959, pp. 330-334. With a change of lookup tables, the same core algorithm and hardware can also do multiplication, division, and square roots, and also the hyperbolic, exponential, and logarithmic functions as described in J. Walther, “A unified algorithm for elementary functions,” Proceedings of the Spring Joint Computer Conference of the American Federation of Information Processing Societies, vol. 38. AFIPS Press, 1971, pp. 379-385. Essentially, CORDIC performs the rotation of a vector |x,y| by an angle z in generalized coordinate systems, as presented in Equation 6:

$$\{ \begin{matrix}x [ i + 1 ] = x [ i ] - m σ [ i ] {2}^{- i} y [ i ] \\ y [ i + 1 ] = y [ i ] - σ [ i ] {2}^{- i} x [ i ] \\ z [ i + 1 ] = z [ i ] - σ [ i ] arctan ( {2}^{- i} ) \\ i = i + 1\end{matrix} \qquad ( 6 )$$

where m is 1 for circular, 0 for linear, and −1 for hyperbolic coordinate systems. For rotation mode σ(i)+1 if z(i)≧0, otherwise is −1; for vectoring mode, σi)=−1 if y(i)≧0, otherwise is +1.

Both the CCM and CORDIC methods require programmable shift operations for which the existing fine- or coarse-grain reconfigurable arrays either do not provide architectural support or embed dedicated shift units in the reconfigurable fabric. For example, the MATRIX array described in E. Mirsky and A. DeHon, “MATRIX: A Reconfigurable Computing Architecture with Configurable Instruction Distribution and Deployable Resources,” Proceedings of the 4th IEEE Symposium in FPGAs for Custom Computing Machines. Napa Valley, Calif., April 1996, pp. 157-166, implements a shift operation within the ALU, PipeRench described in S. C. Goldstein, H. Schmit, M. Moe, M. Budiu, S. Cadambi, R. R. Taylor, and R. Laufer, “PipeRench: A Coprocessor for Streaming Multimedia Acceleration,” Proceedings of the 26th International Symposium in Computer Architecture, Atlanta, Ga., May 1999, pp. 28-39, embeds a dedicated barrel shifter into the device, both the Masively Parallel Reconfigurable Architecture and Programming for Wireless Communications described in K. Sarrigeorgidis and J. M. Rabaey, “A Scalable Configurable Architecture for Advanced Wireless Communication Algorithms,” Journal of VLSI Signal Processing, vol. 45, no. 3, December 2006, pp. 127-151, and the design described in S.-J. Yih, M. Cheng, and W.-S. Feng, “Multilevel barrel shifter for CORDIC design,” Electronics Letters, vol. 32, no. 13, June 1996, pp. 1178-1179, perform shift within a dedicated CORDIC unit, while RaPiD described in C. Ebeling, D. C. Cronquist, and P. Franklin, “RaPiD—Reconfigurable Pipelined Datapath,” Proceedings of the 6th International Workshop on Field Programmable Logic and Applications. Field-Programmable Logic: Smart Applications, New Paradigms and Compilers, ser. Lecture Notes in Computer Science (LNCS), vol. 1142. Springer-Verlag, September 1996, pp. 126-135, emulates shift by multiplication by a power of two. All these solutions based on custom units embedded into the reconfigurable fabric incur a large cost in terms of silicon area, propagation delay, or power consumption.

It is the objective of this invention to disclose a method that allows a shift operation to be performed within the interconnection network of a reconfigurable array. This way, shift operations can be executed without the penalties incurred by embedding dedicated shift units into the reconfigurable fabric.

### BRIEF DESCRIPTION OF THE INVENTION

For those skilled in the art, it is apparent that both CCM and CORDIC algorithms can be implemented using the following operations: (1) Shift-and-Add; (2) table look-up; (3) sign detection. It is also apparent that only unidirectional shift to the right rather than bidirectional shift is needed. Although these are standard operations being supported virtually by any embedded processor, a pure-software solution is inherently slow even on powerful parallel processors, since both CCM and CORDIC algorithms are sequential. A full-custom solution under the form of a hardware assist is much faster, but it comes at the expense of flexibility. A possible trade-off between the software and hardware solutions can be achieved under the reconfigurable computing paradigm.

The architecture of a coarse-grain reconfigurable array that performs programmable shift operations within its interconnection network rather than its computing tiles is disclosed. As mentioned, a coarse-grain array typically consists of a set of coarse-grain computing tiles, e.g., Arithmetic Logic Unit (ALU), surrounded by a programmable interconnection network that provides word-level routing operations. Assume N is the word-length of the coarse-grain computing tile. The connection point for a coarse-grain array is then an N-by-N diagonal matrix of switches, which is called a diagonal switch-box. To enable programmable right-shift within the interconnection network of such an array, the diagonal matrix of switches is replaced with a lower-triangular matrix of switches, which is called a triangular switch-box. It is apparent to one of ordinary skill in the art that left-shift is enabled by an upper-triangular matrix of switches. Thusly, the right-shift or left-shift operations are supported depending on the lower- or upper-triangular type of the switch-box. Due to the increased capacitive load of the interconnection bus, the triangular switch-box may still have slightly less performance in terms of propagation delay and power consumption than the diagonal switch-box. However, since the triangular switch-box implements the computation performed by a diagonal switch-box connected in series with a shift unit, it provides better performance when the switch and shift functions are both required.

Two types of computing tiles that perform two Shift-and-Add/Subtract operations per iteration and two Add-and-Select operation, respectively, are also disclosed. The reconfigurable array is organized on layers, in which layers of computing tiles are interleaved with layers of interconnection buses. Each layer of computing tiles reads in operands from the layer above, and writes the results to the layer below. An interconnection bus contains diagonal switch-boxes to support switching functions, as well as triangular switch-boxes to support switching and shifting functions.

### BRIEF DESCRIPTION OF THE DRAWINGS

The subsequent description of the detailed description of the invention section makes reference to the accompanying drawings, in which:

FIG. 1 shows triangular and diagonal switch-boxes.

FIG. 2 shows a Shift-And-Add/Subtract (SAAS) computing tile together with an interconnection layer.

FIG. 3 shows a Add-and-Select (ASEL) computing tile together with an interconnection layer.

FIG. 4 shows the architecture of an interconnection layer together with a computing layer.

### DETAILED DESCRIPTION OF THE INVENTION

Specific embodiments of the invention will now be described in detail with references to the accompanying figures. Like elements in the various figures are denoted by like reference numerals throughout the figures for consistency.

In the following detailed description of the invention, numerous specific details are set forth in order to provide a more thorough understanding of the invention. However, it will be apparent to one of ordinary skill in the art that the invention may be practiced without these specific details. In order instances, well-known features have not been described in detail to avoid obscuring the invention.

Since a shift operation is only a shuffling or rearrangement of the signals and not a combination of the signals, the functionality of the interconnection network can be extended with shift capabilities. Given the fact that an interconnection network connects wires and buses in a flexible way, it should in principle be also able to connect shifted versions of these buses, and thus implicitly support shift operations.

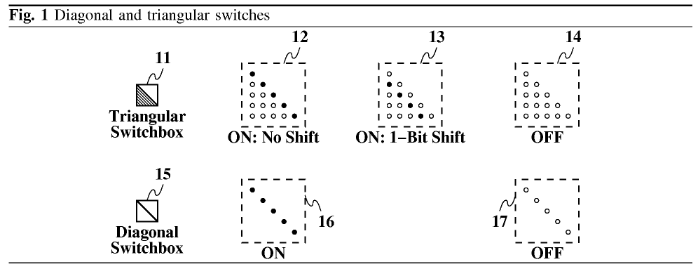

The connection point in a coarse-grain reconfigurable array is a diagonal matrix of switches (15), also called a diagonal switch-box, in which only the main diagonal is populated with switches, as shown in FIG. 1. The diagonal switch-box can be either in an ON state (16) in which the switches are activated, or in an OFF state (17) in which no switches are activated. On the other hand, an array shift unit has the shift bit lines meshing across all input data lines, where at each crossing point a switch will either allow or not allow the input data value to pass to the output line. Since there is only one switch between the input data lines and the output data lines, the shift operation is performed in a single stage as described in N. Weste and D. Harris, CMOS VLSI Design: A Circuits and Systems Perspective, third edition, Addison Wesley, 2004. The execution of the Shift-and-Add operation on a coarse-grain reconfigurable array is optimized by merging a diagonal switch-box with an array shift unit. The resulting switch-box is a triangular matrix of transfer gates (11), also referred to as a triangular switch-box, with intrinsic shift capability, as shown in FIG. 1. The triangular switch-box can be in an ON state with no shift (12) in which the main diagonal of switches is activated, an ON state with shift (13) in which a subdiagonal of switches is activated, or in an OFF state (14) in which no switches are activated.

The reconfigurable array is organized on layers, in which layers of computing tiles (210) are interleaved with layers of interconnection buses (211). Each layer of computing tiles reads in operands from the registers (201) in the layer above, and writes the results to the registers (202) in the layer below. The number of computing tiles on a computing layer is equal to the number of interconnection buses on the interconnection layer below. This allows a hardwired connection between a computing tile output and an interconnection bus. The inputs of a computing tile can be programmed to be any of the buses in the interconnection layer above. This programmability is provided by means of diagonal switch-boxes (15) and triangular switch-boxes (11).

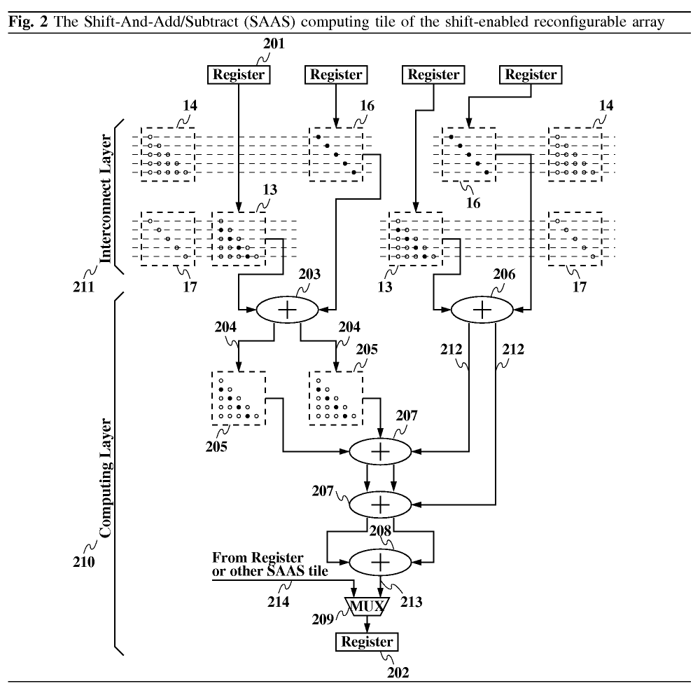

The convergence range of the CCM and CORDIC algorithms is increased by using the double iteration method as described in I. Koren, Computer Arithmetic Algorithms, second edition, A. K. Peters, 2001, and J.-M. Muller, Elementary Functions: Algorithms and Implementation, second edition, Birkhäuser Boston, 2005. A computing tile that implements two Shift-And-Add/Subtract (SAAS) iterations per pipeline stage is presented in FIG. 2. First, the outputs of the previous computing layer are propagated through the interconnection layer (211) to implement the first shift operation. To perform the second shift operation without waiting for the adder's carry to propagate, the first adder is a carry-save adder (203). Carry-save adders are described for example in I. Koren, Computer Arithmetic Algorithms, second edition, A. K. Peters, 2001, and J.-M. Muller, Elementary Functions: Algorithms and Implementation, second edition, Birkhäuser Boston, 2005. Each of the resulting carry and sum words (204) is propagated through dedicated shift units (205). The addition on the right path is also performed using a carry-save adder (206) and generates the carry and sum words (212). The final operation is a four-operand addition implemented with two carry-save adders (207) and one ripple-carry adder (208). A selection between the final sum (213) and a signal that originates from previous layer or other SAAS unit is performed by multiplexer (209).

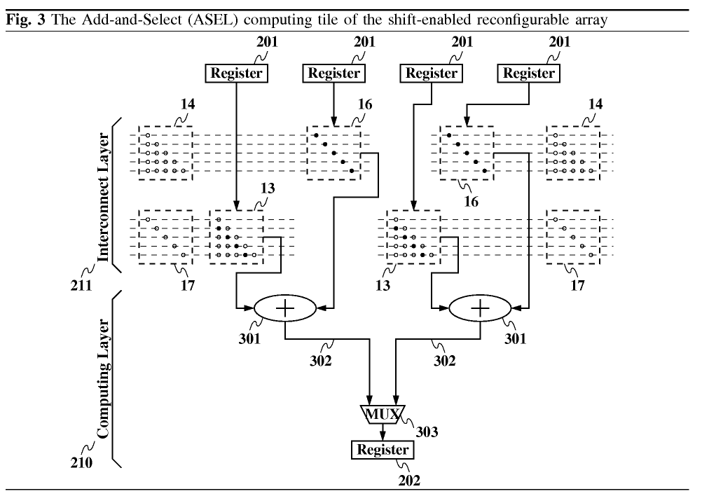

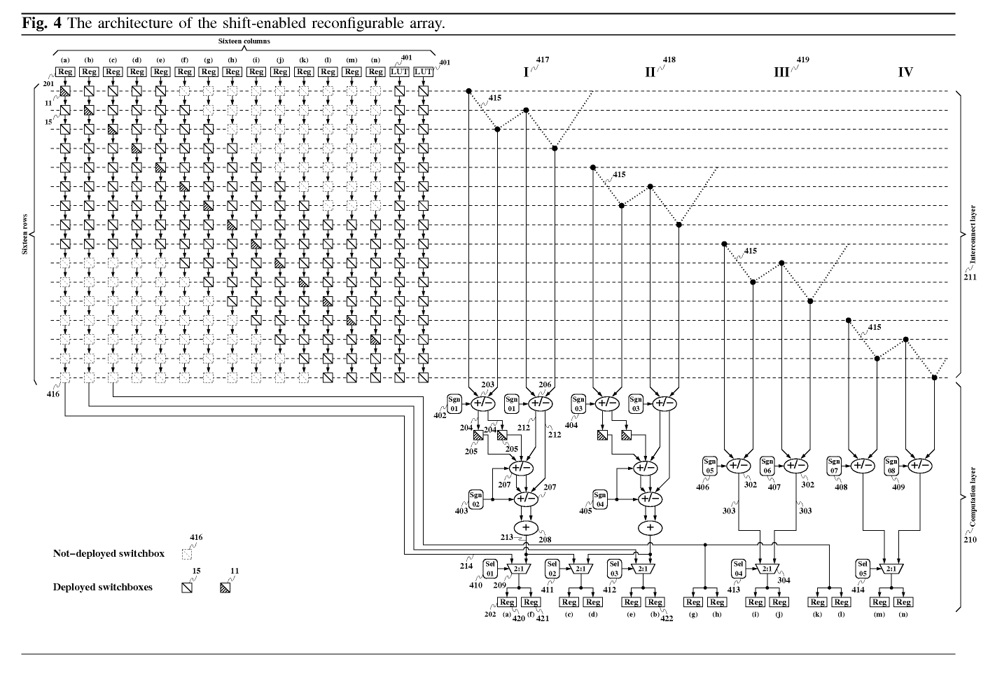

A computing tile that implements an Add-and-Select (ASEL) operation is presented in FIG. 3. First, the outputs of the previous computing layer are propagated through the interconnection layer (211) to the ripple-carry adders (301). The ripple-carry adders (301) implement two addition (or subtraction) operations. Then the multiplexor (303) selects one of the sums (302) to be stored into a register (202). The architecture of a interconnection layer together with the architecture of a computing layer are presented in FIG. 4. In a preferred embodiment, the interconnection layer has sixteen rows and sixteen columns of diagonal and triangular switch-boxes. In a preferred embodiment, there is a single triangular switch-box per row. In addition, to reduce the full matrix of switch-boxes to a band-matrix of switch-boxes with the purpose of reducing the electrical load and silicon area, hardwired shuffling is provided between computing tiles and registers. For example, the first tile writes the result back into Register (a) (420) and Register (f) (421) rather than Register (a) (420) and Register (b) (422), as shown in FIG. 4. Also, a hardwired shuffling from interconnection layer to the tiles' inputs under the form of a W-shaped connections (415) is provided. This way, the result value of the first computing tile (417) can be supplied to tiles II (418) and III (419) while the number of diagonal switch-boxes above and below a triangular switch-box is at most eight. Therefore, a large number of switch-boxes (416) need not be deployed. The rightmost two columns (401) provide the additive constants. As such, there is no need to implement shift operations for the two rightmost columns, and, therefore, there are no triangular switchboxes on these two columns. All the considered transcendental functions can be mapped onto the disclosed shift-enabled reconfigurable array with this reduced connectivity as described in M. Sima, M. McGuire, and S. Miller, “Reconfigurable Array for Transcendental Functions Calculation,” Proceedings of IEEE International Conference on Field-Programmable Technology, Taipei, Taiwan, December 2008, pp. 49-56.

A set of control signals is also provided. The Signum control signals, Sgn_{—}01 (402), Sgn_{—}02 (403), Sgn_{—}03 (404), Sgn_{—}04 (405), Sgn_{—}05 (406), Sgn_{—}06 (407), Sgn_{—}07 (408), and Sgn_{—}08 (409) select which one of the addition and subtraction operations is to be performed. The Selection control signals, Sel_{—}01 (410), Sel_{—}02 (411), Sel_{—}03 (412), Sel_{—}04 (413), and Sel_{—}05 (414) configure the multiplexors at the computing tiles' outputs. Each control signal can be configured to be the most-significant (sign) bit of any column.

The disclosed shift-enabled reconfigurable array is configured statically like an FPGA. A configuration bit stream is serially loaded and defines the transcendental function to be calculated. In particular, the configuration information specifies: (1) the order of the shift operation required for each pipeline stage, (2) selection of the operations to be performed by each individual computing tiles (addition or subtraction), and (3) the 2:1 multiplexors configuration.

The description of the present embodiment of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as discussed and illustrated.

What is claimed is:

1) A coarse-grain reconfigurable array, comprising:
a) a plurality of computing tiles, each of said computing tiles receiving a plurality of word-level input signals and generating a plurality of word-level output signals,
b) a programmable interconnection network providing word-level routing operations to connect said word-level output signals with word-level input signals,
c) said programmable interconnection network having matrices of switches as programmable connection points for enabling programmable shift operations within said word-level input signals or said word-level output signals in addition to said word-level routing operations,
whereby said matrices of switches enable the execution of said programmable shift operations within said word-level input signals or said word-level output signals within said programmable interconnection network in addition to said word-level routing operations.

2) The coarse-grain reconfigurable array of claim 1 wherein said programmable interconnection network has triangular matrices of switches as programmable connection points for enabling programmable unidirectional shift operations within said word-level input signals or said word-level output signals in addition to said word-level routing operations.

3) The coarse-grain reconfigurable array of claim 1 wherein said programmable interconnection network has fully populated matrices of switches as programmable connection points for enabling programmable shuffle operations within said word-level input signals or said word-level output signals in addition to said word-level routing operations.

4) A method of performing programmable shift operations within the programmable interconnection network of a coarse-grain reconfigurable array, comprising:
a) providing a plurality of computing tiles, each of said computing tiles receiving a plurality of word-level input signals and generating a plurality of word-level output signals,
b) providing said programmable interconnection network providing word-level routing operations to connect said word-level output signals with said word-level input signals,
c) providing said programmable interconnection network having matrices of switches as programmable connection points which will
i) allow the activation of a subdiagonal rather than the main diagonal of each said matrix of switches,
ii) causing shifted versions of said word-level output signals or said word-level input signals to be propagated through said programmable interconnection network,
whereby said programmable interconnection network is able to implement programmable shift operations within said word-level input signals or said word-level output signals in addition to said word-level routing operations.

5) The method of claim 4 wherein said programmable interconnection network has triangular matrices of switches as programmable connection points such that said programmable interconnection network is able to implement programmable unidirectional shift operations within said word-level input signals or said word-level output signals in addition to said word-level routing operations.

6) The method of claim 4 wherein said programmable interconnection network has fully populated matrices of switches as programmable connection points such that said programmable interconnection network is able to implement programmable shuffle operations within said word-level input signals or said word-level output signals in addition to said word-level routing operations.

7) A coarse-grain reconfigurable array, comprising:
a) a plurality of computing layers where each said computing layer comprises a plurality of computing tiles, each of said computing tiles receiving a plurality of word-level input signals and generating a plurality of word-level output signals,
b) a programmable interconnection network that comprises a plurality of interconnection layers, each of said interconnection layers providing word-level routing operations to connect said word-level output signals with word-level input signals, each of said interconnection layers being able to perform programmable shift operations within said word-level input signals or said word-level output signals in addition to said word-level routing operations, and
c) said computing layers that are interleaved with said interconnection layers,
whereby said coarse-grain reconfigurable array performs shift operations within said programmable interconnection network and other operations within said coarse-grain computing tiles in a pipelined fashion.

8) The coarse-grain reconfigurable array of claim 7 wherein said programmable interconnection network has triangular matrices of switches as programmable connection points such that said programmable interconnection network is able to implement programmable unidirectional shift operations within said word-level input signals or said word-level output signals in addition to said word-level routing operations.

9) The coarse-grain reconfigurable array of claim 7 wherein said programmable interconnection network has fully populated matrices of switches as programmable connection points such that said programmable interconnection network is able to implement programmable shuffle operations within said word-level input signals or said word-level output signals in addition to said word-level routing operations.
